(19) United States
(12) Patent Application Publication
(10) Pub. No.: US 2022/0056306 A1
(43) Pub. Date: Feb. 24, 2022

(54) SURFACE PROTECTION COATING AGENT, CURED PRODUCT, AND LAMINATE, AND METHOD OF PRODUCING THE SAME

(71) Applicant: ARAKAWA CHEMICAL INDUSTRIES, LTD., Osaka (JP)

(72) Inventors: Yuki HASHIMOTO, Osaka (JP); Shotaro TOGAMI, Osaka (JP); Yoshiki ITO, Osaka (JP); Akihiro YAMAZAKI, Osaka (JP)

(73) Assignee: ARAKAWA CHEMICAL INDUSTRIES, LTD., Osaka (JP)

(21) Appl. No.: 17/398,015

(22) Filed: Aug. 10, 2021

(30) Foreign Application Priority Data
Aug. 11, 2020 (JP) 2020-135504

(51) Int. Cl. C09D 175/14; C08G 18/73; C08G 18/62; C08G 18/24

(52) U.S. Cl. CPC C09D 175/14; C08G 18/246; C08G 18/6229; C08G 18/73

(57) ABSTRACT

There are provided a surface protection coating agent, a cured product, and a laminate and a method of producing the same. The disclosure provides a surface protection coating agent including a polymer (A) including a structural unit 1 derived from long chain alkyl group-containing (meth)acrylic acid ester and a structural unit 2 derived from a hydroxy group-containing (meth)acrylic monomer and a polyisocyanate (B).

### CROSS-REFERENCE TO RELATED APPLICATION

This application claims the priority benefit of Japan application no. 2020-135504, filed on Aug. 11, 2020. The entirety of the above-mentioned patent application is hereby incorporated by reference herein and made a part of this specification.

### BACKGROUND

### Technical Field

The disclosure relates to a surface protection coating agent, a cured product, and a laminate, and a method of producing the same.

### Description of Related Art

Plastic substrates such as ABS and polycarbonate are used in various industrial products such as electronic devices and automobile components. In order to protect such a plastic substrate, a surface treatment is performed with a coating agent.

Self-healing properties are imparted to coating agents in order to eliminate scratches formed over time (Patent Document 1 (Japanese Patent Laid-Open No. 2010-043261) and Patent Document 2 (Japanese Patent Laid-Open No. 2016-033175)).

The disclosure is to provide a coating agent for producing a laminate having favorable elongation, self-healing properties, and antifouling properties.

The inventors conducted extensive studies and as a result, found that the above coating agent is achieved using specific components.

### SUMMARY

The disclosure provides the following item.

A surface protection coating agent including a polymer (A) including a structural unit 1

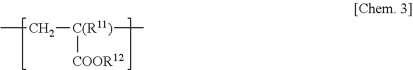

(in the formula, R¹¹ is a hydrogen atom or a methyl group, and R¹² is an alkyl group having 8 to 22 carbon atoms),
and
a structural unit 2

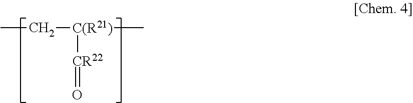

(in the formula, R²¹ is a hydrogen atom or a methyl group, R²² is NHR^{2′} or OR^{2′}, and R^{2′} is a hydroxy group-containing alkyl group); and
a polyisocyanate (B).

### DESCRIPTION OF THE EMBODIMENTS

The disclosure provides the following items.

### (Item 1)

A surface protection coating agent including a polymer (A) including a structural unit 1

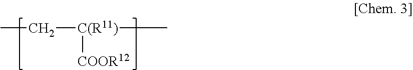

(in the formula, R¹¹ is a hydrogen atom or a methyl group, and R¹² is an alkyl group having 8 to 22 carbon atoms),
and
a structural unit 2

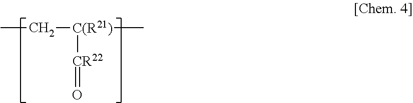

(in the formula, R²¹ is a hydrogen atom or a methyl group, R²² is NHR^{2′} or OR^{2′}, and R^{2′} is a hydroxy group-containing alkyl group); and
a polyisocyanate (B).

### (Item 2)

A cured product of the surface protection coating agent according to the above item.

### (Item 3)

A laminate including the cured product according to the above item and a substrate.

### (Item 4)

A method of producing a laminate including a process of heating a substrate of which at least one surface is coated with the surface protection coating agent according to the above item.

In the disclosure, the above one or more embodiments may be provided in additional combinations in addition to specified combinations.

It is possible to obtain a laminate having favorable elongation, self-healing properties, and antifouling properties using the surface protection coating agent of the disclosure.

Throughout the disclosure, the ranges of numerical values such as each physical property value and a content can be appropriately set (for example, by selecting from upper limit and lower limit values described in the following items). Specifically, regarding the numerical value α, when A4, A3, A2, A1 (A4>A3>A2>A1), and the like are exemplified as the upper limit and the lower limit of the numerical value α, the range of the numerical value α may be, for example, A4 or less, A3 or less, A2 or less, A1 or more, A2 or more, A3 or more, A1 to A2, A1 to A3, A1 to A4, A2 to A3, A2 to A4, or A3 to A4.

[Surface protection coating agent: also called a coating agent] The disclosure provides a surface protection coating agent including a polymer (A) including a structural unit 1

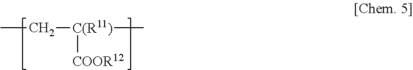

(in the formula, R¹¹ is a hydrogen atom or a methyl group, and R¹² is an alkyl group having 8 to 22 carbon atoms),
and
a structural unit 2

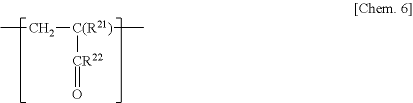

(in the formula, R²¹ is a hydrogen atom or a methyl group, R²² is NHR^{2′} or OR^{2′}, and R^{2′} is a hydroxy group-containing alkyl group); and
a polyisocyanate (B).

<Polymer (A): Also Referred to as a Component (A)>

The components (A) may be used alone or two or more thereof may be used.

(Structural Unit 1)

The structural unit 1 is a structural unit included in the polymer (A) when a long chain alkyl group-containing (meth)acrylic acid ester (a1)

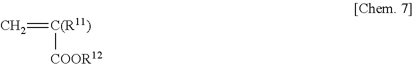

(in the formula, R¹¹ is a hydrogen atom or a methyl group, and R¹² is an alkyl group having 8 to 22 carbon atoms) is used as a monomer. The long chain alkyl group-containing (meth)acrylic acid esters (a1) may be used alone or two or more thereof may be used.

Examples of alkyl groups include a linear alkyl group, a branched alkyl group, and a cycloalkyl group.

The linear alkyl group is represented by the general formula —CₙH₂ₙ₊₁ (n is an integer of 1 or more).

The branched alkyl group is a group having no cyclic structure in which at least one hydrogen atom of a linear alkyl group is substituted with an alkyl group.

Examples of cycloalkyl groups include a monocyclic cycloalkyl group, a crosslinked ring cycloalkyl group, and a condensed ring cycloalkyl group. Here, a group in which at least one hydrogen atom of a cycloalkyl group is substituted with an alkyl group is also referred to as a cycloalkyl group.

In the disclosure, a monocycle is a cyclic structure formed by covalent bonds of carbon and having no bridge structure therein. In addition, the condensed ring is a cyclic structure in which two or more monocycles share two atoms (that is, only one side of each ring is shared (condensed)). A crosslinked ring is a cyclic structure in which two or more monocycles share three or more atoms.

Examples of upper limits and lower limits of the number of carbon atoms of R¹² include 22, 21, 20, 19, 18, 17, 16, 15, 14, 13, 12, 11, 10, 9, and 8. In one embodiment, the number of carbon atoms of R¹² may be 8 to 22.

In one embodiment, R¹² is, for example, an alkyl group having 8 to 22 carbon atoms, or an alkyl group having 8 to 12 carbon atoms, or a 2-ethylhexyl group or a lauryl group.

Examples of alkyl groups having 8 to 22 carbon atoms include linear, branched, and cycloalkyl groups such as octyl groups, nonyl groups, decyl groups, undecyl groups, dodecyl groups, tridecyl groups, tetradecyl groups, pentadecyl groups, hexadecyl groups, heptadecyl groups, octadecyl groups (stearyl groups), nonadecyl groups, eicosyl groups, heneicosyl groups, and docosyl groups.

Examples of long chain alkyl group-containing (meth)acrylic acid esters include octyl (meth)acrylate, nonyl (meth)acrylate, decyl (meth)acrylate, undecyl (meth)acrylate, lauryl (meth)acrylate, tridecyl (meth)acrylate, myristyl (meth)acrylate, pentadecyl (meth)acrylate, palmityl (meth)acrylate, heptadecyl (meth)acrylate, stearyl (meth)acrylate, nonadecyl (meth)acrylate, eicosyl (meth)acrylate, heneicosyl (meth)acrylate, and docosyl (meth)acrylate.

Examples of upper limits and lower limits of the content of the structural unit 1 with respect to 100 mass % of the polymer (A) include 95, 90, 85, 80, 78, 76.8, 75, 74, 70, 65.2, 65, 61, 60, 59, 55, 50, 45, 40, 37.5, 36, 35, 30, 26, 25.5, 25, and 20 mass %. In one embodiment, the content may be 20 to 95 mass %.

Examples of upper limits and lower limits of the content of the structural unit 1 with respect to 100 mol % of the polymer (A) include 90, 85, 75, 70, 65, 60, 55, 50, 45, 40, 35, 30, 25, 20, 15, and 10 mol %. In one embodiment, the content may be 10 to 90 mol %.

(Structural Unit 2)

The structural unit 2 is a structural unit included in the polymer (A) when a hydroxy group-containing (meth)acrylic monomer (a2)

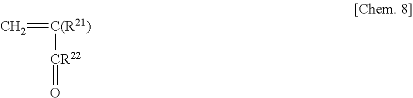

(in the formula, R²¹ is a hydrogen atom or a methyl group, R²² is NHR^{2′} or OR^{2′}, and R^{2′} is a hydroxy group-containing alkyl group) is used as a monomer. The hydroxy group-containing (meth)acrylic monomers (a2) may be used alone or two or more thereof may be used.

In the disclosure, “hydroxy group-containing alkyl group” is a group in which one or more hydrogen atoms of an alkyl group are substituted with a hydroxy group. Examples of hydroxy group-containing alkyl groups include hydroxy group-containing linear alkyl groups, hydroxy group-containing branched alkyl groups, and hydroxy group-containing cycloalkyl groups.

In the disclosure, examples of upper limits and lower limits of the number of carbon atoms of hydrocarbon groups, which do not refer to the number of carbon atoms of hydrocarbon groups (alkyl groups, alkylene groups, arylene groups, arylene alkylene arylene groups, etc.) include 30, 29, 25, 20, 19, 18, 17, 16, 15, 14, 13, 12, 11, 10, 9, 8, 7, 6, 5, 4, 3, 2, and 1.

Examples of hydroxy group-containing (meth)acrylic monomers (a2) include hydroxy group-containing (meth)acrylic ester and hydroxy group-containing (meth)acrylamide.

Examples of hydroxy group-containing (meth)acrylic esters include 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 1,4-cyclohexanedimethanol mono(meth)acrylate, and glycerin mono(meth)acrylate.

Examples of hydroxy group-containing (meth)acrylamides include N-(2-hydroxyethyl)(meth)acrylamide, N-(1-methyl-2-hydroxyethyl)(meth)acrylamide, N-hydroxymethyl(meth)acrylamide, and N-(2-hydroxypropyl)(meth)acrylamide.

Examples of upper limits and lower limits of the content of the structural unit 2 with respect to 100 mass % of the polymer (A) include 80, 75, 70, 65, 60, 55, 50, 45, 40, 35, 34.8, 30, 25, 23.2, 20, 19, 17, 16, 15, 11.5, 10, 5.5, and 5 mass %. In one embodiment, the content may be 5 to 80 mass %.

Examples of upper limits and lower limits of the content of the structural unit 2 with respect to 100 mol % of the polymer (A) include 90, 85, 80, 75, 70, 65, 60, 55, 50, 45, 40, 35, 30, 25, 20, 15, and 10 mol %. In one embodiment, the content may be 10 to 90 mol %.

Examples of upper limits and lower limits of the mass ratio between the structural unit 1 and the structural unit 2 with respect to the polymer (A) (mass of structural unit 1/mass of structural unit 2) include 19, 17, 15, 14, 11, 10, 9, 7, 6.8, 6.4, 5.2, 5, 4, 3.5, 3.3, 3, 2.3, 2, 1.9, 1.8, 1.5, 1.4, 1, 0.9, 0.7, 0.5, 0.3, and 0.25. In one embodiment, the mass ratio may be 0.25 to 19.

Examples of upper limits and lower limits of the substance amount ratio between the structural unit 1 and the structural unit 2 with respect to the polymer (A) (substance amount of structural unit 1/substance amount of structural unit 2) include 14, 12, 10, 9, 7, 5, 4, 3, 2, 1, 0.9, 0.7, 0.5, 0.3, 0.2, and 0.1. In one embodiment, the substance amount ratio may be 0.1 to 14.

(Structural Unit 3)

In one embodiment, the polymer (A) may include a structural unit 3:

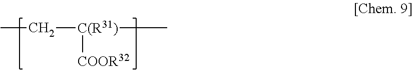

(in the formula, R³¹ is a hydrogen atom or a methyl group, and R³² is an alkyl group having 1 to 7 carbon atoms).

The structural unit 3 is a structural unit included in the polymer (A) when a short chain alkyl group-containing (meth)acrylic acid ester (a3)

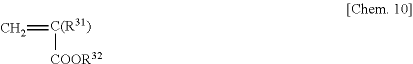

(in the formula, R³¹ is a hydrogen atom or a methyl group, and R³² is an alkyl group having 1 to 7 carbon atoms) is used as a monomer.

Examples of alkyl groups having 1 to 7 carbon atoms include linear, branched, and cycloalkyl groups such as a methyl group, an ethyl group, a propyl group, a butyl group, a pentyl group, a hexyl group, and a heptyl group.

Examples of upper limits and lower limits of the content of the structural unit 3 with respect to 100 mass % of the polymer (A) include 70, 65, 60, 57.5, 55, 51, 50, 48, 46, 45, 40, 35, 33.5, 30, 28.5, 25, 24, 20, 15, 14.5, 11, 10, 9, 7, 5, 4, 2, 1, 0.9, 0.5, 0.1, and 0 mass %. In one embodiment, the content may be 0 to 70 mass %.

Examples of upper limits and lower limits of the content of the structural unit 3 with respect to 100 mol % of the polymer (A) include 90, 85, 80, 75, 70, 65, 60, 55, 50, 45, 40, 35, 30, 25, 20, 15, 10, 9, 7, 5, 4, 3, 2, 1, and 0 mol %. In one embodiment, the content may be 0 to 90 mol %.

(Structural Units Other than Structural Units 1 to 3: Also Referred to as Other Structural Units)

In one embodiment, the polymer (A) may include structural units other than the structural units 1 to 3.

Examples of structural units other than the structural units 1 to 3 include structural units included in the polymer (A) when a multi-functional (meth)acrylate such as a (meth)acrylate, styrene, an alkenyl (meth)acrylate, a (meth)acrylamide, a (meth)acrylonitrile, or ethylene glycol di(meth)acrylate is used as a monomer.

The content of the other structural units with respect to 100 mass % of the polymer (A) may be, for example, less than 5 mass %, less than 2 mass %, less than 1 mass %, less than 0.1 mass %, or 0 mass %. In addition, the content of the other structural units with respect to 100 mass % of any one of the structural units 1 to 3 may be, for example, less than 5 mass %, less than 2 mass %, less than 1 mass %, less than 0.1 mass %, or 0 mass %.

The content of the other structural units with respect to 100 mol % of the polymer (A) may be, for example, less than 5 mol %, less than 2 mol %, less than 1 mol %, less than 0.1 mol %, or 0 mol %. In addition, the content of the other structural units with respect to 100 mol % of any one of the structural units 1 to 3 may be, for example, less than 5 mol %, less than 2 mol %, less than 1 mol %, less than 0.1 mol %, or 0 mol %.

<Physical Properties and the Like of Polymer (A)>

Examples of upper limits and lower limits of the number average molecular weight of the polymer (A) include 80,000, 75,000, 70,000, 50,000, 40,000, 30,000, 26,000, 25,000, 20,000, 17,500, 16,000, 15,800, 15,700, 15,000, 14,200, 14,000, 13,600, 13,000, 12,500, 10,000, and 8,000. In one embodiment, the number average molecular weight may be 8,000 to 80,000.

Examples of upper limits and lower limits of the weight average molecular weight of the polymer (A) include 200,000, 190,000, 170,000, 150,000, 100,000, 90,000, 75,000, 70,000, 60,000, 55,000, 52,500, 52,300, 50,000, 40,000, 39,500, 38,100, 37,400, 37,000, 36,000, 35,000, 25,000, and 20,000. In one embodiment, the weight average molecular weight may be 20,000 to 200,000.

The weight average molecular weight and the number average molecular weight can be determined as a polystyrene conversion value measured in a suitable solvent by, for example, gel permeation chromatography (GPC). Detailed conditions are exemplified as follows.

Model: product name “HLC-8220” (commercially available from Tosoh Corporation)
Column: product name “PLgel MIXED-C” (commercially available from Agilent Technology)×2
Eluent, flow rate: tetrahydrofuran, 1.0 mL/min
Measurement temperature: 40° C.

### Detector: RI

Standard: monodisperse polystyrene
Polymer concentration: 0.2%

Examples of upper limits and lower limits of the hydroxyl value of the polymer (A) include 200, 190, 175, 150, 140, 125, 100, 90, 85, 82, 80, 75, 50, 40, 35, 30, 25, 22, 20, 15, and 10 mg KOH/g. In one embodiment, the hydroxyl value of the polymer (A) may be 10 to 200 mg KOH/g.

The hydroxyl value is measured by a method according to JIS K1557-1.

In addition, if the amount of prepared monomers used when a polymer is produced can be accurately determined and the polymerization rate is high, the hydroxyl value can be calculated by the following formula.

Hydroxyl value=[(prepared mass of hydroxy group-containing monomers in 1 g of all prepared monorriers×the number of hydroxy groups of one molecule of hydroxy group-containing monomers)/molecular weight of hydroxy group-containing monomers]×56.11 (molecular weight of KOH)×1,000 (1)

Examples of upper limits and lower limits of the glass transition temperature (Tg) of the polymer (A) include 60, 55, 50, 45, 40, 35, 30, 25, 20, 15, 10, 5, 0, −5, −10, −15, −20, −25, −30, −35, −40, −45, −50, −55, and −60° C. In one embodiment, the glass transition temperature (Tg) may be −60 to 60° C.

The glass transition temperature is calculated by the Fox formula.

1/Tg=(Wa/Tga)+(Wb/Tgb)+ . . . +(Wn/Tgn) Fox formula:

Tg: glass transition temperature (K) of copolymer
Wa: mass % of monomer A
Tga: glass transition temperature (K) of homopolymer of monomer A
Wb: mass % of monomer B
Tgb: glass transition temperature (K) of homopolymer of monomer B
Wn: mass % of monomer N
Tgn: glass transition temperature (K) of homopolymer of monomer N

Examples of methods of producing the polymer (A) include various known radical polymerizations. Radical polymerization can be performed by heating in the presence of a radical polymerization initiator.

Examples of radical polymerization initiators include inorganic peroxides such as hydrogen peroxide, ammonium persulfate, and potassium persulfate, organic peroxides such as benzoyl peroxide, dicumyl peroxide, and lauryl peroxide, and azo compounds such as 2,2′-azobisisobutyronitrile and dimethyl-2,2′-azobisisobutyrate. The radical polymerization initiators may be used alone or two or more thereof may be used. The amount of the radical polymerization initiator used may be about 1 to 10 parts by mass with respect of 100 parts by mass of all monomer components.

When the polymer (A) is produced, as necessary, a chain transfer agent may be used. Examples of chain transfer agents include lauryl mercaptan, dodecyl mercaptan, 2-mercaptobenzothiazole, bromotrichloromethane, and α-methylstyrene dimer. The chain transfer agents may be used alone or two or more thereof may be used. The amount of the chain transfer agent used may be about 0 to 5 parts by mass with respect to 100 parts by mass of all monomer components.

Examples of upper limits and lower limits of the content of the polymer (A) with respect to 100 mass % of the coating agent solid content include 95, 90, 85, 80, 75, 70, 65, 60, 55, 50, and 45 mass %. In one embodiment, the content may be 45 to 95 mass %.

<Polyisocyanate (B): Also Referred to as a Component (B)>

The polyisocyanates may be used alone or two or more thereof may be used.

In the disclosure, “polyisocyanate” is a compound having two or more isocyanate groups (—N═C═O).

Examples of polyisocyanates include linear aliphatic polyisocyanates, branched aliphatic polyisocyanates, alicyclic polyisocyanates, aromatic polyisocyanates and biuret forms thereof, isocyanurate forms (nurate forms), allophanate forms, and adduct forms.

Examples of linear aliphatic polyisocyanates include methylene diisocyanate, dimethylene diisocyanate, trimethylene diisocyanate, tetramethylene diisocyanate, pentamethylene diisocyanate, hexamethylene diisocyanate, heptamethylene diisocyanate, octamethylene diisocyanate, nonamethylene diisocyanate, and decamethylene diisocyanate.

Examples of branched aliphatic polyisocyanates include diethylpentylene diisocyanate, trimethylbutylene diisocyanate, trimethylpentylene diisocyanate, and trimethylhexamethylene diisocyanate.

Examples of alicyclic polyisocyanates include monocyclic alicyclic polyisocyanate, crosslinked ring alicyclic polyisocyanate, and condensed ring alicyclic polyisocyanate.

Examples of monocyclic alicyclic polyisocyanates include hydrogenated xylene diisocyanate, isophorone diisocyanate, cyclopentylene diisocyanate, cyclohexylene diisocyanate, cycloheptylene diisocyanate, cyclodecylene diisocyanate, 3,5,5-trimethylcyclohexylene diisocyanate, and dicyclohexylmethane diisocyanate.

Examples of crosslinked ring alicyclic polyisocyanates include tricyclodecylene diisocyanate, adamantane diisocyanate, and norbornene diisocyanate.

Examples of condensed ring alicyclic polyisocyanates include bicyclodecylene diisocyanate.

Examples of aromatic groups include a monocyclic aromatic group and a condensed ring aromatic group. In addition, one or more hydrogen atoms of the aromatic group may be substituted with a linear or branched alkyl group.

Examples of monocyclic aromatic groups include a phenyl group (phenylene group), a tolyl group (tolylene group), and a mesityl group (mesitylene group). In addition, examples of condensed ring aromatic groups include a naphthyl group (naphthalene group).

Examples of aromatic polyisocyanates include monocyclic aromatic polyisocyanate and condensed ring aromatic polyisocyanate.

Examples of monocyclic aromatic polyisocyanates include dialkyldiphenylmethane diisocyanate such as 4,4′-diphenyldimethylmethane diisocyanate, tetraalkyl diphenylmethane diisocyanate such as 4,4′-diphenyltetramethylmethane diisocyanate, and 4,4′-diphenylmethane diisocyanate, 4,4′-dibenzylisocyanate, 1,3-phenylenediisocyanate, 1,4-phenylene diisocyanate, tolylene diisocyanate, xylylene diisocyanate, and m-tetramethylxylylene diisocyanate.

Examples of condensed ring aromatic polyisocyanates include 1,5-naphthylene diisocyanate.

Examples of biuret forms of polyisocyanate include compounds represented by the following structural formula:

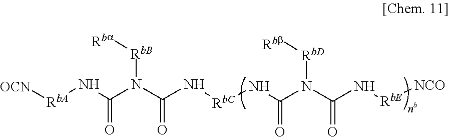

[in the formula,
n^{b} is an integer of 0 or more,
R^{bA} to R^{bE} are each independently an alkylene group or an arylene group,
R^{bα} to R^{bβ} are each independently an isocyanate group or

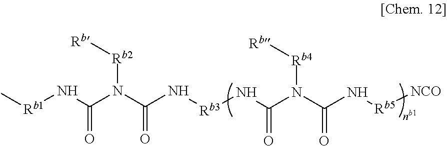

(n^{b1} is an integer of 0 or more,
R^{b1} to R^{b5} are each independently an alkylene group or an arylene group,
R^{b}′ to R^{b}″ are each independently an isocyanate group or groups of R^{bα} to R^{bβ} themselves.
the groups of R^{b4} to R^{b5}, and R^{b}″ may be different for each structural unit).
the groups of R^{bD} to R^{bE}, and R^{bβ} may be different for each structural unit].

Examples of biuret forms of polyisocyanate include DURANATE 24A-100, DURANATE 22A-75P, and DURANATE 21S-75E (all commercially available from Asahi Kasei Corporation), and Desmodur N3200A (biuret form of hexamethylene diisocyanate) (all commercially available from Sumika Covestro Urethane Co., Ltd.).

Examples of isocyanurate forms of polyisocyanate include compounds represented by the following structural formula:

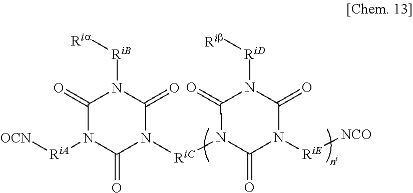

[in the formula, nⁱ is an integer of 0 or more,
R^{iA} to R^{iE} are each independently an alkylene group or an arylene group,
R^{iα} to R^{iβ} are each independently an isocyanate group or

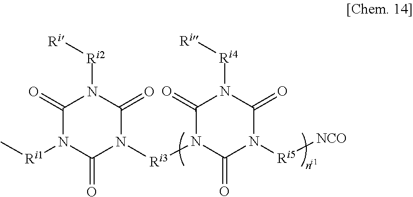

(nⁱ¹ is an integer of 0 or more,
Rⁱ¹ to Rⁱ⁵ are each independently an alkylene group or an arylene group,
Rⁱ′ to Rⁱ″ are each independently an isocyanate group or groups of R^{iα} to R^{iβ} themselves.
the groups of Rⁱ⁵ and Rⁱ″ may be different for each structural unit).
the groups of R^{iD} to R^{iE}, and R^{iβ} may be different for each structural unit].

Examples of commercial products of isocyanurate forms of polyisocyanate include DURANATE TPA-100, DURANATE TKA-100, DURANATE MFA-75B, and DURANATE MHG-80B (all commercially available from Asahi Kasei Corporation), Coronate HXR, Coronate HX, Coronate HK (isocyanurate form of hexamethylene diisocyanate), Coronate 2037 (all commercially available from Tosoh Corporation), Takenate D-127N (isocyanurate form of hydrogenated xylene diisocyanate), Takenate D-131N (isocyanurate form of xylene diisocyanate), Takenate D-204EA-1 (isocyanurate form of toluene diisocyanate) (all commercially available from Mitsui Chemicals Inc), and VESTANAT T1890/100 (isocyanurate form of isophorone diisocyanate) (all commercially available from Evonik Japan Co., Ltd.).

Examples of allophanate forms of polyisocyanate include compounds represented by the following structural formula:

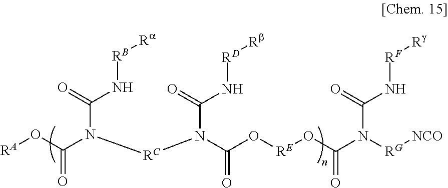

[in the formula, n is an integer of 0 or more, R^{A} is an alkyl group or an aryl group, R^{B} to R^{G} are each independently an alkylene group or an arylene group, and R^{α} to R^{γ} are each independently an isocyanate group or

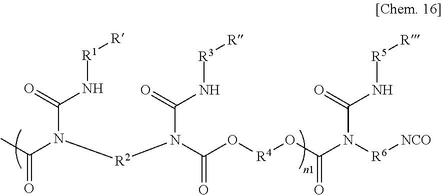

(n1 is an integer of 0 or more, R¹ to R⁶ are each independently an alkylene group or an arylene group, and R′ to R′″ are each independently an isocyanate group or groups of R^{α} to R^{γ} themselves. The groups of R¹ to R⁴, and R′ to R″ may be different for each structural unit), the groups of R^{B} to R^{E}, and R^{α} to R^{β} may be different for each structural unit].

Examples of commercial products of allophanate forms of polyisocyanate include Coronate 2793 (commercially available from Tosoh Corporation), and Takenate D-178N (commercially available from Mitsui Chemicals Inc).

Examples of adduct forms of polyisocyanate include an adduct form of trimethylolpropane and polyisocyanate represented by the following structural formula:

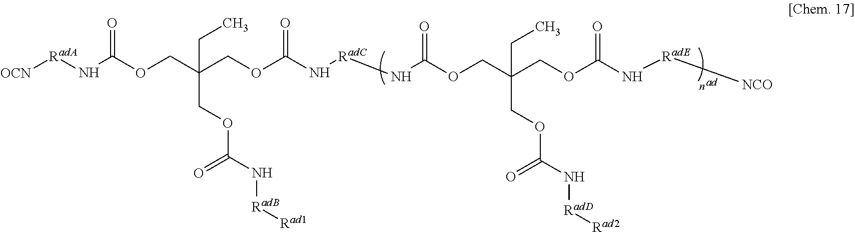

[in the formula, n^{ad} is an integer of 0 or more, R^{adA} to R^{adE} are each independently an alkylene group or an arylene group, and R^{ad1} to R^{ad2} are each independently

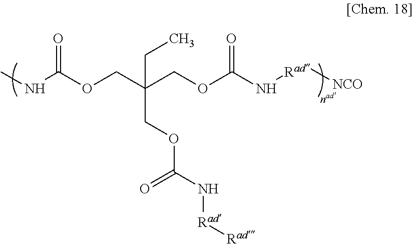

(in the formula, n^{ad′} is an integer of 0 or more,
R^{ad′} to R^{ad″} are each independently an alkylene group or an arylene group,
R^{ad′″} is the groups of R^{ad1} to R^{ad2} themselves,
the groups of R^{ad′} to R^{ad′″} may be different for each structural unit).
The groups of R^{adD} to R^{adE}, and R^{ad2} may be different for each structural unit], and an adduct form of glycerin and polyisocyanate represented by the following structural formula

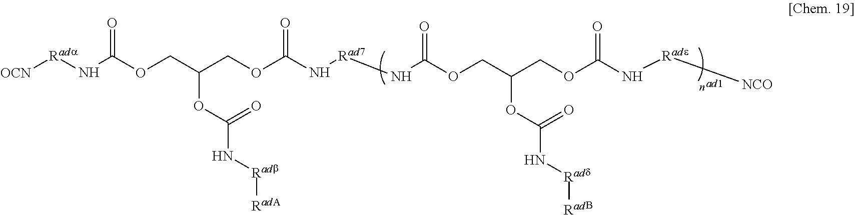

[in the formula, n^{ad1} is an integer of 0 or more,
R^{adα} to R^{adε} are each independently an alkylene group or an arylene group,
R^{adA} to R^{adB} are each independently

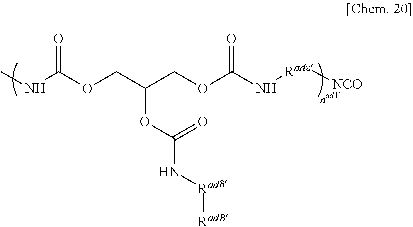

(in the formula, n^{ad1′} is an integer of 0 or more,
R^{adδ′} to R^{adε′} are each independently an alkylene group or an arylene group,
R^{adB′} is the groups R^{adA} to R^{adB} themselves,
the groups of R^{adδ′} to R^{adε′}, and R^{adB′} may be different for each structural unit)
the groups of R^{adδ} to R^{adε} may be different for each structural unit].

Examples of adduct forms of polyisocyanate include DURANATE P301-75E (commercially available from Asahi Kasei Corporation), Takenate D110N and Takenate D160N (all commercially available from Mitsui Chemicals Inc), and Coronate L and Coronate HL (all commercially available from Tosoh Corporation).

Examples of upper limits and lower limits of the NCO content (NCO %) of polyisocyanate include 30, 25, 20, 15, and 10%. In one embodiment, the NCO content (NCO %) may be 10 to 30%.

Examples of upper limits and lower limits of an isocyanate group equivalent of polyisocyanate include 420, 400, 350, 300, 250, 200, 150, and 140 g/eq. In one embodiment, the isocyanate group equivalent may be 140 to 420 g/eq.

In the disclosure, the isocyanate group equivalent is a calculated value (g/eq) of the mass per mol of the isocyanate group.

Examples of upper limits and lower limits of the ratio (NCO/OH) of totals of the isocyanate group equivalent of polyisocyanate and the hydroxy group equivalent of the polymer (A) include 5, 4, 3, 2, 1.5, 1.2, 1, 0.9, 0.75, 0.5, 0.25, 0.1, and 0.05. In one embodiment, the ratio (NCO/OH) may be 0.05 to 5.

Examples of upper limits and lower limits of the content of polyisocyanate with respect to 100 mass % of the coating agent solid content include 55, 50, 45, 40, 35, 30, 25, 20, 15, 10, and 5 mass %. In one embodiment, the content may be 5 to 55 mass %.

Examples of upper limits and lower limits of the mass ratio between the component (A) and the component (B) contained in the coating agent [total mass of the component (A) contained in the coating agent/total mass of the component (B) contained in the coating agent] include 19, 17, 15, 13, 12.5, 12, 11, 10, 9, 7, 6.3, 6, 5, 4.5, 4, 3.9, 3.8, 3.1, 3, 2.1, 2, 1, 0.9, and 0.8. In one embodiment, the mass ratio may be 0.8 to 19.

<Organic Modified Silicone (C): Also Referred to as a Component (C)>

In one embodiment, the coating agent may contain an organic-modified silicone. The components (C) may be used alone or two or more thereof may be used.

In the disclosure, “organic-modified silicone” refers to silicone into which an organic group is introduced. Examples of organic-modified silicone include side chain type organic-modified silicone, double-end type organic-modified silicone, single-end type organic-modified silicone, and side chain double-end type organic-modified silicone.

Examples of organic-modified silicone include hydroxy group-containing organic-modified silicone, amino group-containing organic-modified silicone, epoxy group-containing organic-modified silicone, mercapto group-containing organic-modified silicone, and carboxyl group-containing organic-modified silicone.

Examples of hydroxy group-containing organic-modified silicone include hydroxy group-containing acrylic resin-modified silicone, hydroxy group-containing polyester resin-modified silicone, hydroxy group-containing polyether resin-modified silicone, and hydroxy group-containing carbinol resin-modified silicone.

Examples of commercial products of hydroxy group-containing acrylic resin-modified silicone include ZX-028-G (commercially available from T&K TOKA Corporation), BYK-SILCLEAN3700 (commercially available from BYK-Chemie Japan), and Symac US-270 (commercially available from Toagosei Co., Ltd.).

Examples of commercial products of hydroxy group-containing polyester resin-modified silicone or hydroxy group-containing polyether resin-modified silicone include BYK-370, BYK-375, BYK-377, BYK-SILCLEAN3720 (commercially available from BYK-Chemie Japan), and X-22-4952, KF-6123 (commercially available from Shin-Etsu Chemical Co., Ltd.).

Examples of commercial products of hydroxy group-containing carbinol resin-modified silicone include X-22-4039, X-22-4015, X-22-4952, X-22-4272, X-22-170BX, X-22-170DX, KF-6000, KF-6001, KF-6002, KF-6003, KF-6123, X-22-176F (commercially available from Shin-Etsu Chemical Co., Ltd.), Silaplane FM-4411, Silaplane FM-4421, Silaplane FM-4425, Silaplane FM-0411, Silaplane FM-0421, Silaplane FM-DA11, Silaplane FM-DA21, and Silaplane FM-DA26 (commercially available from JNC).

Examples of commercial products of amino group-containing organic-modified silicone include KF-868, KF-865, KF-864, KF-859, KF-393, KF-860, KF-880, KF-8004, KF-8002, KF-8005, KF-867, KF-8021, KF-869, KF-861, KF-877, KF-889, and X-22-3939A (commercially available from Shin-Etsu Chemical Co., Ltd.).

Examples of commercial products of epoxy group-containing organic-modified silicone include X-22-343, KF-101, KF-1001, X-22-2000, X-22-2046, KF-102, X-22-4741, KF-1002, and KF-1005 (commercially available from Shin-Etsu Chemical Co., Ltd.).

Examples of commercial products of mercapto group-containing organic-modified silicone include KF-2001 and KF-2004 (commercially available from Shin-Etsu Chemical Co., Ltd.).

Examples of commercial products of carboxyl group-containing organic-modified silicone include X-22-3701E (commercially available from Shin-Etsu Chemical Co., Ltd.).

Examples of upper limits and lower limits of the content of the hydroxy group-containing silicone-modified resin with respect to 100 mass % of the coating agent solid content include 5, 4.5, 4, 3.5, 3, 2.5, 2, 1.5, 1, 0.5, 0.4, 0.2, 0.1, and 0 mass %. In one embodiment, the content may be 0 to 5.0 mass %.

<Curing Catalyst (D): Also Referred to as a Component (D)>

In one embodiment, the coating agent may contain a curing catalyst. The curing catalysts may be used alone or two or more thereof may be used.

Examples of curing catalysts include an organic metal catalyst and an organic amine catalyst.

Examples of organic metal catalysts include an organic typical metal catalyst and an organic transition metal catalyst.

Examples of organic typical metal catalysts include an organic tin catalyst and an organic bismuth catalyst.

Examples of organic tin catalysts include dibutyl tin dilaurate and dioctyl tin dilaurate.

Examples of organic bismuth catalysts include bismuth octylate.

Examples of organic transition metal catalysts include an organic titanium catalyst, an organic zirconium catalyst, and an organic iron catalyst.

Examples of organic titanium catalysts include titanium ethyl acetoacetate.

Examples of organic zirconium catalysts include zirconium tetraacetylacetone.

Examples of organic iron catalysts include iron acetylacetonate.

Examples of organic amine catalysts include diazabicyclooctane, dimethylcyclohexylamine, tetramethylpropylene diamine, ethyl morpholine, dimethylethanolamine, trimethylamine and triethylenediamine.

Examples of upper limits and lower limits of the content of the curing catalyst with respect to 100 mass % of the coating agent solid content include 1, 0.9, 0.7, 0.5, 0.3, 0.2, 0.1, and 0 mass %. In one embodiment, the content may be 0 to 1.0 mass %.

<Organic Solvent (E): Also Referred to as a Component (E)>

In one embodiment, the coating agent may contain an organic solvent. The organic solvents may be used alone or two or more thereof may be used.

In consideration of solubility in the resin, the organic solvent may be methyl ethyl ketone, methyl isobutyl ketone, cyclohexanone, ethyl acetate, butyl acetate, propylene glycol monomethyl ether acetate, or toluene.

Examples of upper limits and lower limits of the content of the organic solvent with respect to 100 mass % of the coating agent include 90, 85, 80, 75, 70, and 65 mass %. In one embodiment, the content may be 65 to 90 mass %.

Examples of upper limits and lower limits of the solid content (non-volatile content) of the coating agent include 35, 30, 25, 20, 15, and 10%. In one embodiment, the solid content (non-volatile content) may be 10 to 35%.

<Additives>

The coating agent may contain an agent that does not correspond to any of the components (A) to (E) as an additive.

Examples of additives include antifoaming agents, anti-lubricants, preservatives, rust inhibitors, pH adjusting agents, antioxidants, pigments, dyes, lubricants, leveling agents, conduction agents, polybutadiene, polyisoprene, polychloroprene, polypentadiene, polybutene, polyisobutylene, polystyrene, isoprene-butadiene copolymers, styrene-isoprene copolymers, polyolefin and derivatives thereof, silicone resins, isocyanate group-containing compounds, epoxy group-containing compounds, amines, carboxylic acid anhydride, and long chain alkyl group-containing alcohols.

In one embodiment, the content of the additive with respect to 100 parts by mass of the coating agent may be, for example, less than 1 part by mass, less than 0.1 parts by mass, less than 0.01 parts by mass, and 0 parts by mass. In addition, the content may be, for example, less than 1 part by mass, less than 0.1 parts by mass, less than 0.01 parts by mass, or 0 parts by mass with respect to 100 parts by mass of any of the components (A) to (E).

The coating agent can be prepared by dispersing and mixing the components (A) to (B), and as necessary, the components (C) to (E) and additives by various known devices. Here, the order of addition of respective components is not particularly limited. In addition, various known devices (an emulsifying dispersing machine, an ultrasonic dispersing device, etc.) can be used as the dispersing and mixing device.

The surface protection coating agent can be used as a thermosetting surface protection coating agent, a self-healing surface protection coating agent, a thermosetting surface self-healing protective coating agent, a surface protection coating agent for a paint protection film, a thermosetting surface protection coating agent for a paint protection film, a self-healing surface protection coating agent for a paint protection film, or a thermosetting surface self-healing protective coating agent for a paint protection film.

The paint protection film (PPF) is attached to a coating surface of a car body of an automobile or motorcycle and protects the coating surface of the car body from flying stones and dirt. When the PPF is attached to the coating surface of the car body, it is attached while stretched (deformed) so that it conforms to the curved surface of the car body. Therefore, when the coating agent is used to produce a paint protection film, the produced laminate can be required to have favorable elongation.

[Cured Product]

The disclosure provides a cured product of the surface protection coating agent.

In one embodiment, the cured product is a thermosetting product of the surface protection coating agent. Curing conditions are exemplified as follows.

[Laminate]

The disclosure provides a laminate including the above cured product and a substrate.

Examples of substrates include substrates made of a plastic such as polycarbonate, polymethyl methacrylate, polystyrene, polyethylene terephthalate (PET), polyethylene naphthalate, polyimide, polyolefin, nylon, a urethane resin, an epoxy resin, a melamine resin, a triacetylcellulose resin, an ABS resin, or a norbornene resin.

The substrate may be subjected to a surface treatment (corona discharge or the like) as necessary. In addition, a layer formed of a coating agent other than the coating agent of the disclosure may be provided on one surface or both surfaces of the substrate.

[Method of Producing Laminate: Also Called a Production Method]

The disclosure provides a method of producing a laminate including a process of heating a substrate of which at least one surface is coated with the surface protection coating agent.

Examples of coating methods include using spraying, a roll coater, a reverse roll coater, a gravure coater, a knife coater, a bar coater, and a dot coater.

The coating amount is not particularly limited. The coating amount is an amount at which the mass after drying is, for example, about 3 to 25 g/m², or 5 to 20 g/m².

Examples of heating methods include drying using a circulating air dryer or the like. Examples of drying (curing) conditions include a temperature of about 90 to 170° C. and a time of about 30 seconds to 2 minutes.

In one embodiment, the production method includes a curing process. Examples of curing conditions include room temperature and heating conditions. When heating is performed, a temperature of about 40 to 60° C. and a time of about 1 to 7 days may be exemplified.

### EXAMPLES

Hereinafter, the disclosure will be described in detail with reference to examples and comparative examples. However, the description in the above embodiments and the following examples are provided only for the purpose of illustration, and are not intended to limit the disclosure. Therefore, the scope of the disclosure is not limited to the embodiments or examples specifically described in this specification, but is limited only by the claims. In addition, in the examples and comparative examples, unless otherwise specified, numerical values of parts, percentages and the like are based on mass.

### Production Example 1

35 parts of lauryl acrylate, 19 parts of 2-hydroxyethyl methacrylate, and 46 parts of methyl methacrylate were put into a 4-neck flask including a stirrer, a reflux cooling pipe, a nitrogen introduction pipe, a thermometer, and a dropping funnel, 2 parts of azobisisobutyronitrile as an initiator and 153 parts of ethyl acetate as a solvent were put thereinto, and the mixture was gradually heated to 77° C., and reacted for 9 hours to obtain a polymer solution with a solid content concentration of 40% (a number average molecular weight of 26,000 and a weight average molecular weight of 70,000).

Production examples other than Production Example 1 and comparative production examples were performed in the same manner as in Production Example 1 except that components were changed as shown in the following table.

TABLE 1

| | | Produc- | Produc- | Produc- | Produc- | Produc- | Produc- | Produc- | Produc- |
|---|---|---|---|---|---|---|---|---|---|
| | | tion | tion | tion | tion | tion | tion | tion | tion |
| | | Example | Example | Example | Example | Example | Example | Example | Example |
| | | 1 | 2 | 3 | 4 | 5 | 6 | 7 | 8 |
| Structural | 2EHA | — | — | — | — | — | — | — | — |
| unit 1 | LA | 35 | 36 | 37.5 | 59 | 25.5 | 65.2 | 76.8 | — |
| | LMA | — | — | — | — | — | — | — | 60 |
| | SA | — | — | — | — | — | — | — | — |
| Structural | HEMA | 19 | 16 | 11.5 | — | — | 34.8 | 23.2 | 11.5 |
| unit 2 | HEA | — | — | — | 17 | 17 | — | — | — |
| Structural | MMA | 46 | 48 | 51 | 24 | 57.5 | — | — | 28.5 |
| unit 3 | BA | — | — | — | — | — | — | — | — |
| Glass transition | | 40 | 40 | 40 | 0 | 40 | 0 | −8 | −22 |
| temperature (° C.) | | | | | | | | | |
| Hydroxyl value | | 82 | 70 | 50 | 82 | 82 | 150 | 100 | 50 |
| (mgKOH/g) | | | | | | | | | |
| | | | Produc- | Produc- | Produc- | Produc- | | | |
| | | | tion | tion | tion | tion | Comparative | Comparative | Comparative |
| | | | Example | Example | Example | Example | Production | Production | Production |
| | | | 9 | 10 | 11 | 12 | Example 1 | Example 2 | Example 3 |
| | Structural | 2EHA | — | — | 26 | — | — | — | — |
| | unit 1 | LA | — | — | — | — | — | — | — |
| | | LMA | 74 | 61 | — | — | — | — | — |
| | | SA | — | — | — | 78 | — | — | — |
| | Structural | HEMA | 11.5 | 5.5 | 19 | 11.5 | — | — | — |
| | unit 2 | HEA | — | — | — | — | 17 | 17 | 17 |
| | Structural | MMA | 14.5 | 33.5 | 55 | 11 | 24 | 65 | 80 |
| | unit 3 | BA | — | — | — | — | 59 | 18 | 3 |

| | | | | | | | |
|---|---|---|---|---|---|---|---|
| Glass transition | −40 | −22 | 40 | 40 | −22 | 40 | 70 |
| temperature (° C.) | | | | | | | |
| Hydroxyl value | 50 | 25 | 82 | 50 | 82 | 82 | 82 |
| (mgKOH/g) | | | | | | | |

### EXPLANATION OF ABBREVIATIONS

2EHA: 2-ethylhexyl acrylate
LA: lauryl acrylate
LMA: lauryl methacrylate
SA: stearyl acrylate
HEMA: 2-hydroxyethyl methacrylate
HEA: 2-hydroxyethyl acrylate
MMA: methyl methacrylate
BA: butyl acrylate

### Example 1

100 parts of the polymer of Production Example 1 in terms of solid content, 26 parts of DURANATE 24A-100 (commercially available from Asahi Kasei Corporation, biuret form of hexamethylene diisocyanate (with a solid content concentration of 100%)), 0.03 parts of dioctyltin dilaurate (with a solid content concentration of 100%, hereinafter referred to as DOTDL), 209 parts of methyl ethyl ketone (hereinafter referred to as MEK), and 19.0 parts of acetylacetone (hereinafter referred to as AcAc) were mixed well to prepare a thermosetting coating agent with a solid content concentration of 25%.

Examples other than Example 1 and comparative examples were performed in the same manner as in Example 1 except that components were changed as shown in the following table.

TABLE 2

| | | | Component | | NCO/ | Elongation | Self-healing | |
|---|---|---|---|---|---|---|---|---|
| | Component A | Content | B | Content | OH | (%) | properties | Contamination |
| Example 1 | Production Example 1 | 100 | 24A-100 | 26 | 1 | 100 | Δ | ⊚ |
| Example 2 | Production Example 2 | 100 | 24A-100 | 22 | 1 | 110 | Δ | ⊚ |
| Example 3 | Production Example 3 | 100 | 24A-100 | 16 | 1 | 140 | ◯ | ⊚ |
| Example 4 | Production Example 4 | 100 | 24A-100 | 26 | 1 | 140 | ⊚ | ◯ |
| Example 5 | Production Example 5 | 100 | 24A-100 | 26 | 1 | 110 | Δ | ⊚ |
| Example 6 | Production Example 6 | 100 | 24A-100 | 48 | 1 | 110 | ◯ | ◯ |
| Example 7 | Production Example 7 | 100 | 24A-100 | 32 | 1 | 110 | ⊚ | ◯ |
| Example 8 | Production Example 8 | 100 | 24A-100 | 16 | 1 | 130 | ⊚ | ⊚ |
| Example 9 | Production Example 9 | 100 | 24A-100 | 16 | 1 | 140 | ◯ | ⊚ |
| Example 10 | Production Example 10 | 100 | 24A-100 | 8 | 1 | 210 | ◯ | ◯ |
| Example 11 | Production Example 11 | 100 | 24A-100 | 26 | 1 | 120 | Δ | ⊚ |
| Example 12 | Production Example 12 | 100 | 24A-100 | 16 | 1 | 140 | ◯ | ⊚ |
| Example 10 | Production Example 4 | 100 | TPA-100 | 26 | 1 | 130 | ◯ | ⊚ |
| Comparative | Comparative | 100 | 24A-100 | 26 | 1 | 160 | ⊚ | X |
| Example 1 | Production Example 1 | | | | | | | |
| Comparative | Comparative | 100 | 24A-100 | 26 | 1 | 110 | X | ◯ |
| Example 2 | Production Example 2 | | | | | | | |
| Comparative | Comparative | 100 | 24A-100 | 26 | 1 | 80 or less | X | ◯ |
| Example 3 | Production Example 3 | | | | | | | |
| Comparative | Production Example 1 | 100 | 303LF | 26 | 0 | 100 | X | ⊚ |
| Example 4 | | | | | | | | |

### EXPLANATION OF ABBREVIATIONS

24A-100: DURANATE 24A-100, commercially available from Asahi Kasei Corporation, biuret form of hexamethylene diisocyanate (with a solid content concentration of 100%)
TPA-100: DURANATE TPA-100, commercially available from Asahi Kasei Corporation, isocyanurate form of hexamethylene diisocyanate (with a solid content concentration of 100%)
303LF: CYMEL 303LF, commercially available from Allnex Japan Corporation, full ether type methylated melamine resin

<Production of Laminate>

The coating agent was applied to a thermoplastic urethane film (with a thickness of 185 μm) with a bar coater so that the coating thickness after drying was 10 and dried at 120° C. for 2 minutes. Then, aging was performed at 40° C. for 2 days to produce a laminate.

<Elongation>

The above test piece was punched out with a JIS-3 dumbbell, and measurement was performed under conditions of a tensile speed of 200 mm/min and a distance between markers of 20 mm using a Tensilon universal tensile testing machine (product name “RTC-1250A,” commercially available from A&D Co., Ltd.).

Elongation at break (%)=100×(L−20)/20

L: length of the cured product when the cured product is broken

<Self-Healing Properties>

The surface of the laminate was scratched 10 oscillations in an oscillatory manner with a brass brush, and the time until scratches disappeared was measured.

∘: Restored within 3 seconds
◯: Restored within 4 seconds to 10 seconds
Δ: Restored within 11 seconds to 1 minute
x: Not restored

<Evaluation of Contamination Resistance>

A mark was written on the surface of the laminate with Magic Ink No. 700 (commercially available from Teranishi Chemical Industry Co., Ltd.), and the mark was wiped off with a waste cloth into which ethanol was impregnated after 1 minute for evaluation. Evaluation criteria are as follows.

⊚: The mark completely disappeared after being wiped in 10 oscillations
◯: The mark completely disappeared after being wiped in 11 or more oscillations
x: Could not be wiped off

What is claimed is:

1. A surface protection coating agent comprising a polymer (A) including
a structural unit 1 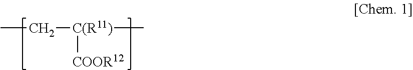
in the formula, R¹¹ is a hydrogen atom or a methyl group, and R¹² is an alkyl group having 8 to 22 carbon atoms,
and
a structural unit 2 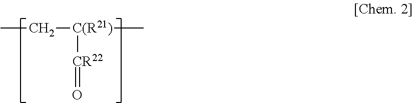
in the formula, R²¹ is a hydrogen atom or a methyl group, R²² is NHR^{2′} or OR^{2′}, and R^{2′} is a hydroxy group-containing alkyl group; and
a polyisocyanate (B).

2. A cured product of the surface protection coating agent according to claim 1.

3. A laminate comprising the cured product according to claim 2 and a substrate.

4. A method of producing a laminate, comprising
a process of heating a substrate of which at least one surface is coated with the surface protection coating agent according to claim 1.
